(19) United States
(12) Patent Application Publication
(10) Pub. No.: US 2026/0104679 A1
(43) Pub. Date: Apr. 16, 2026

(54) COMPUTER-IMPLEMENTED METHOD FOR GENERATING AT LEAST ONE WEIGHTED TRAINING EXAMPLE, USE OF AT LEAST ONE WEIGHTED TRAINING EXAMPLE FOR TRAINING A BEHAVIOR PLANNER, BEHAVIOR PLANNER

(71) Applicant: Robert Bosch GmbH, Stuttgart (DE)

(72) Inventors: Marcel Hallgarten, Ehningen (DE); Martin Stoll, Renningen (DE)

(21) Appl. No.: 19/346,789

(22) Filed: Oct. 1, 2025

(30) Foreign Application Priority Data
Oct. 11, 2024 (DE) 10 2024 209 910.4

(51) Int. Cl. G05B 13/02; B60W 50/00; G05D 1/22; G05D 101/10

(52) U.S. Cl. CPC G05B 13/027; B60W 50/0098; G05D 1/22; B60W 2050/0022; G05D 2101/10

(57) ABSTRACT

A computer-implemented method for generating at least one weighted training example for training a behavior planner for an at least partially automatically driving vehicle or a robot, wherein each training example is a tuple of a state and a corresponding specified target behavior. The method includes: extracting a state from a pre-provided initial training example as the initial state; rolling out a planning strategy of the behavior planner starting from the initial state within a simulation for generating a simulated behavior; terminating the simulation based on a termination condition; evaluating the initial state and/or a state encountered by the simulated behavior in the simulation; weighting a training example on the based on the evaluation of its state and/or at least one state encountered by the simulated behavior after this, wherein the training example is the initial training example and/or a training example newly generated based on an encountered state.

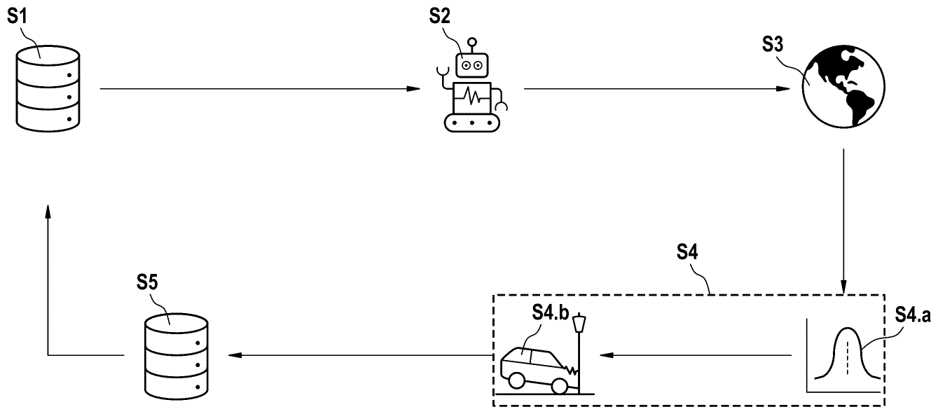

### CROSS REFERENCE

The present application claims the benefit under 35 U.S.C. § 119 of Germany Patent Application No. DE 10 2024 209 910.4 filed on Oct. 11, 2024, which is expressly incorporated herein by reference in its entirety.

### FIELD

The present invention relates to a computer-implemented method for generating at least one weighted training example for training a behavior planner. The present invention further relates to the use of at least one weighted training example generated in accordance with a method according to the present invention for training a behavior planner. Furthermore, the present invention relates to a behavior planner and to an automatically driving vehicle and a robot.

### BACKGROUND INFORMATION

The task of autonomous driving is to control a vehicle on the basis of sensor data (such as radar, lidar, RGB camera) so that a destination is reached as quickly, comfortably and safely as possible, i.e., without causing collisions or violating traffic regulations, for example. This driving task can be divided into the subtasks of perception, prediction, planning and control. The task of perception is to extract relevant information from the sensor data, such as the position of objects (for example, other vehicles or road users), to identify lane markings and to recognize traffic signs, or the like. Since the recognized objects are usually dynamic obstacles, their future position must subsequently be predicted (prediction phase) in order to be able to avoid collisions. Based on this, the task of planning is to generate a trajectory that is adjusted in the control phase. In the planning phase, trainable AI models are often used to create a plan based on an independently learned rule base, the so-called planning strategy. The simplest method to train such a planning strategy is so-called “open loop training,” for example the “behavior cloning” method. A data set previously recorded by an expert is used. Each training example comprises a state and an action selected by the expert. During training, the AI model is confronted with the state of the training example and asked to plan an appropriate action. The action chosen by the AI on the basis of the planning strategy it has learned up to that point is then compared with that of the expert. The planning strategy is trained to imitate the actions selected by the expert as closely as possible. However, such a method is susceptible to so-called distributional shifts. The reason for this is that the states entered by the expert in the training data set systematically differ from those encountered by a planning strategy in reality, because the occurrence of a certain state in principle depends on the action taken in response to the previous state. A planning strategy often does not reach the same result as the expert when selecting actions, so that in reality states are encountered that do not occur in the training data set. The further these states deviate from those in the training data set, the greater the transfer effort required by the planning strategy and the lower the confidence of the planning strategy in its choice of action. The point where AI models are no longer able to plan meaningful behavior is quickly reached. Collisions or uncomfortable behavior and undesirable traffic incidents are the result. Overcoming this problem is made more difficult by the fact that the occurrence of a collision, an undesirable event, or uncomfortable behavior can, due to the chain of states, be causally attributed to a specific wrong decision only with great difficulty, an effect that is referred to as a sequential decision problem.

One means for addressing this problem is so-called “closed-loop training.” With this, the AI model is trained in a simulation. The actions selected by the planning strategy are simulated and the resulting states are ascertained. Subsequently, the planning strategy is applied again to the simulated subsequent states. The states encountered by the planning strategy in the simulation are used for training, for example by generating new training examples based on them. The states used for training are the result of applying the planning strategy, which is why they represent the states encountered by the AI model in reality much better than would be the case with open-loop methods, for example. In addition, the sequential decision problem is modeled much better than with open-loop methods: it is easy to subsequently ascertain which initial situation led to an unfavorable chain of events.

The advantages of closed-loop training are illustrated by the following example: if the planning strategy is trained to control a vehicle, the action could be described by the steering angle and acceleration, and the state by the current dynamic state of the vehicle including associated environmental information (map information, observed vehicles, etc.). In open-loop training, for each training example, the corresponding expert action would be compared with the action selected by the planning strategy, for example by ascertaining the difference in the planned steering angle. It should be noted that only the amount of deviation is important; a deviation in one direction is treated in the same way as a deviation in the other direction. Accordingly, open-loop training is completely blind to subsequent states. Whether the reaction leads to a loss of comfort or a collision is also irrelevant for the training effect. A small deviation in the steering angle is penalized less during the training process than a large one, regardless of whether the small deviation may cause a fatal consequence immediately or in the near future.

In closed-loop training, the steering angle planned by the planning strategy is actually simulated. This makes it possible to explicitly ascertain the consequences of the deviation between the expert action and the chosen action. In this way, the occurrence of a major error, such as a collision or an undesirable event, can in individual cases be traced back to a causal small initial error (for example, a slightly excessive steering angle). Thus, the related art, with closed-loop training, offers a means for predicting the consequences of decisions made in a planning strategy according to its initial state. In this way, when penalizing during the training process, it can be taken into account that an action that would normally be penalized with little punishment indirectly has an unfavorable consequence. However, there is no technical means of capturing the consequences not only with regard to their existence but also with regard to their specific content in a digital and machine-readable form and making them available to a training process. In particular, there is no means of comparatively juxtaposing the consequences of different decisions.

For example, the planning strategy of an automated driving algorithm could require that the vehicle be brought to a stop at a distance of two and a half meters behind a vehicle in front of it. An undesired behavior of the automated algorithm could now exceed or fall below this distance. Both are undesired behaviors and can generally be predicted in close-loop methods, so that the occurrence of an undesired behavior can generally be counteracted. However, in reality, falling below, in particular a negative distance, is considerably less acceptable than exceeding. This circumstance is neither known to the driving algorithm nor can it be adequately taken into account in training, because closed-loop methods, in contrast to open-loop methods, recognize the future occurrence of undesired behavior further into the future, but cannot qualitatively distinguish them from one another. For the sake of completeness, it should be mentioned here that the concepts of reinforcement learning and inverse reinforcement learning represent an exception to this, since they explicitly encode the target behavior in the form of a reward function; however, they suffer from other weaknesses and are therefore not always applicable.

An object of the present invention is to make information about the consequences of decisions made by a planning strategy available to a training process. In order to achieve the object, a method having certain features of the present invention is provided. Preferred embodiments of the present invention are disclosed herein. The present invention also provides a use of at least one method product, a behavior planner, a vehicle, and a robot are specified.

### SUMMARY

A computer-implemented method is provided for generating at least one weighted training example for training a behavior planner for an at least partially automatically driving vehicle or a robot, wherein a training example is understood as a tuple of a state and a corresponding specified target behavior. According to an example embodiment of the present invention, the method includes the following steps:
a) extracting a state from a pre-provided initial training example as the initial state,
b) rolling out a planning strategy of the behavior planner starting from the initial state within a simulation for generating a simulated behavior,
c) terminating the simulation when a termination condition is reached,
d) evaluating the initial state and/or at least one state encountered by the simulated behavior in the simulation,
e) weighting at least one training example on the basis of the evaluation of its state and/or at least one state encountered by the simulated behavior after this, wherein the training example is preferably the initial training example and/or a training example newly generated on the basis of an encountered state.

Rolling out the planning strategy in a simulation makes it possible to recognize which subsequent situations the planning strategy would encounter from a specific state. If serious states such as collisions occur, these are causally related to the previously encountered states via the simulation. This means that all previous states, including the original training example, are supplemented by abstract information about possible consequences, which is encoded in the form of the weighting of the particular training example and can then be automatically taken into account in the training. For example, the training data set can be sorted according to increasing or decreasing severity of consequences (i.e., according to weighting), or during training, particularly severe training examples can be trained more often than others.

According to an example embodiment of the present invention, if the simulation is used in order to generate new training examples automatically, in step e) the new training example(s) are weighted taking into account their own evaluation and/or the individual evaluation of (at least some of) their subsequent states.

According to an example embodiment of the present invention, it is further provided that the termination condition in step c) is a maximum tolerated deviation of the simulated behavior from a target behavior and/or the occurrence of an undesirable event. The deviation of the simulated behavior from the target behavior is also referred to below as undesired behavior. Basing the simulation duration on the occurrence of an undesired behavior and/or an undesirable event rather than, for example, on a simulation time ensures, on the one hand, that the weighting is meaningful and, on the other hand, that no resources are wasted on needlessly continuing the simulation beyond a critical event that should already be avoided at all costs. This keeps the simulation process limited to a reasonable time frame.

An undesirable event is any traffic event to be avoided that has at least an indirect causal connection with the decisions of the behavior planner, for example a collision or a danger or obstruction of another road user or a mere traffic rule violation such as coming to a stop at an intersection. An undesirable event can be determined in the simulation, for example, by monitoring an overlap of object boundaries, so-called bounding boxes. For example, a collision is identified when the object boundary of the vehicle guided by the behavior planner overlaps with the object boundary of another vehicle.

Furthermore, according to an example embodiment of the present invention, it is provided that, in order to achieve the termination condition in step c), a maximum tolerated number of simulation steps or a maximum tolerated simulation time is defined. With this preferred embodiment of the present invention, computing power is primarily saved. If no undesirable event and/or undesired behavior occurs within a specified time, the training example is weighted the same as one that the planning strategy can successfully handle. This is based on the assumption that, beyond a certain distance between an undesirable event and/or undesired behavior and the state under consideration, a causal connection can, without significant disadvantage, be simplistically regarded as not present.

In a further development of the present invention, it is provided that an evaluation point score is used for carrying out the evaluation in step d). The use of an evaluation point score creates the means of incorporating a plurality of aspects proportionally into the evaluation. In one example, a state leads to a traffic rule violation and a collision. By using an evaluation point score, this state can be evaluated differently than another state that leads to a collision without a traffic rule violation. This means of differentiation is advantageous and increases the ultimate benefit of weighting a training example.

In connection with this, it is provided that evaluation points be awarded for the occurrence of undesired behavior and/or undesirable events from a previously created selection of undesired behavior and/or undesirable events. With this preferred embodiment, undesired behavior and/or undesirable events are qualitatively graded from one another once. This gradation can subsequently be taken into account in all future evaluations. Illustrated by a concrete example, this means that the events “collision,” “violation of rules,” and “endangerment,” which would otherwise be evaluated with the binary quantification “undesired,” can be considered in a differentiated manner: through the selection, each event is assigned a different number of evaluation points as needed, in order to reflect, for example, the gradation that a collision carries more weight than an endangerment, which in turn carries more weight than a rule violation. Further events can also be added on an ongoing basis and individual evaluations can be subsequently adjusted without having to repeat the entire evaluation and weighting process, including simulation. In the case of undesired behavior, which by definition initially represents a deviation from the target behavior, a distinction can be made in the selection between a deviation in one or the other direction. Taking up the example already described in the section on the related art, falling below the distance to the vehicle ahead would be evaluated as more serious in the selection than exceeding.

According to an example embodiment of the present invention, it is further provided that evaluation points be awarded for deviations of the simulated behavior from a target behavior, wherein a larger deviation is evaluated with more evaluation points. Thus, the evaluation can not only take into account the occurrence or non-occurrence of certain undesired behaviors (possibly in one direction or the other), but also the amount of deviation from the target behavior, which does not lead to a specific undesirable event, but nevertheless does not correspond to the desired behavior and, due to the amount of deviation, should be treated differently than objectively “correct” behavior with regard to the resulting weighting. Moreover, a training example based on a state that initially leads to a prolonged, materially significant deviation from the target behavior and subsequently to an undesirable event and/or undesired behavior can later be weighted differently from one of which the state initially gives rise to behavior closely following the target behavior but ultimately still results in an undesirable event and/or undesired behavior.

Furthermore, according to an example embodiment of the present invention, it is provided that steps a) to e) are carried out until a quality criterion, preferably the generation of a predefined number of weighted training examples, is reached. With this preferred embodiment, a machine-based chaining of a method according to the present invention is made possible; this in turn provides the means of weighting an entire training data set or also assigning a weight to training examples newly generated using conventional methods.

According to an example embodiment of the present invention, it is also provided that method steps a) to e) be carried out during an ongoing training of the behavior planner. With this preferred embodiment, the weighting can be taken advantage of during training. A weighting of an existing training data set can also be carried out anew after each training-related further development of the planning strategy of the behavior planner, so that the weights always correspond to the current training status of the model.

For this purpose, it is provided that training examples are selected and/or sorted for at least one training epoch based on their weighting and that this selection and/or sorting is used as the basis for at least one training epoch. With this preferred embodiment of the present invention, the weighting of the training examples is used to improve the training effect. Thus, the training process can be designed on the basis of the difficulty or error susceptibility of certain training examples; difficult (i.e., correspondingly weighted) training examples can, for example, be presented more frequently, and a gradual progression from the simple to the difficult, modeled on the curriculum learning approach established in machine learning, is likewise possible by sorting according to weighting.

Furthermore, according to an example embodiment of the present invention, it is provided that the training of the behavior planner be carried out on the basis of a differentiable simulation. Differentiable simulation allows the causal traceability of an event to previous decisions. The differentiable simulation can be used simultaneously for carrying out steps b) and c) of a method according to the present invention. When training with a differentiable simulation, the system is propagated into the future over a fixed time interval, and the simulated behavior or the states encountered in the simulation are compared with a target state and/or a target behavior. Based on the result of this comparison, backpropagation is carried out across all encountered states. In this case, in contrast to behavior cloning, for example, not only the last decision but also the preceding decisions are adjusted by way of weight modification. In this preferred embodiment of the present invention, on the one hand, the advantages of training with differentiable simulation are reaped, while at the same time, by weighting the training example causal for a consequence, the latter is qualitatively detected and made available to the training process.

In order to utilize this circumstance, it is provided in a further development of the present invention that a loss function value is multiplied by a weighting factor prior to carrying out backpropagation, which weighting factor depends on the weighting of a training example causal for the loss function value. With this preferred embodiment, when training with a differentiable simulation, it is made possible to take into account an initially qualitative severity of the event that has occurred or of the error that has occurred in the training effect during backpropagation. For example, critical events such as a collision produce a stronger training effect than less serious events. The loss function is a function that quantifies a deviation of an actual behavior and/or state from a target behavior and/or (respectively) state. A loss function is typically used in the training of neural networks in order to quantify how much a result predicted by the neural network deviates from the target. The loss function value forms the basis for the degree of weight adjustment within the layers of the network in response to the result.

Furthermore, the use of at least one weighted training example generated according to the present invention for training a behavior planner is provided. Training using at least one, preferably a plurality of weighted training examples has the aforementioned advantages.

In addition, a behavior planner for an at least partially automatically driving vehicle and/or a robot is provided, which has been trained using a method according to the present invention. Such a behavior planner has the aforementioned advantages.

According to an example embodiment of the present invention, it is also suggested that the behavior planner is a trajectory planner. A trajectory planner is a behavior planner for designing a trajectory to be driven in a certain traffic situation. This preferred embodiment of the present invention is particularly advantageous because the planning of movements - under which the generation of driving trajectories and/or control commands is to be understood - is often confronted with real situations not occurring in expert behavior and is therefore especially susceptible to instability and lack of robustness in conventional methods such as behavior cloning. Conversely, a trajectory planner particularly benefits from the aforementioned advantages of a behavior planner according to the present invention.

Furthermore, an automatically driving vehicle comprising a behavior planner according to the present invention is provided. Such a vehicle comprises the aforementioned advantages.

Furthermore, a robot comprising a behavior planner according to the present invention is provided. A robot of this type has the aforementioned advantages.

The present invention is explained in more detail below with reference to a FIGURE.

### BRIEF DESCRIPTION OF THE DRAWING

The sole FIGURE shows a schematic representation of a method sequence according to an example embodiment of the present invention.

### DETAILED DESCRIPTION OF EXAMPLE EMBODIMENTS

The FIGURE shows a schematic representation of an exemplary method sequence according to the present invention. In a first method step S1, an arbitrary initial training example is provided from a provided training data set. Based on its state, a planning strategy of a behavior planner is rolled out as part of a simulation in method step S2 until a termination criterion, for example an undesirable event such as a collision, occurs. The states encountered are collected and temporarily stored in a subsequent method step S3. In the next method step S4, the individual states are evaluated. In sub-step S4.a, an evaluation is carried out on the basis of the amount of deviation of the behavior from a target behavior. In sub-step S4.b, an evaluation is carried out on the basis of the occurrence of an undesirable event and/or undesired behavior from a previously created selection. The evaluations are combined into a state-specific evaluation point score. On the basis of the resulting overall evaluation of the individual states, the initial training example is subsequently weighted in a method step S5.

Method steps S1 to S5 are repeated until the entire training data set is weighted. Subsequently, the planning strategy is retrained taking into account the then applicable weights. This consideration is reflected, for example, in sorting the training examples according to weight and/or in more frequent training on correspondingly weighted (ergo: “more difficult”) training examples. After training, method steps S1 to S5 are carried out again using the newly trained planning strategy and the weights of the training examples are adjusted to the capability profile of the planning strategy.

What is claimed is:

1. A computer-implemented method for generating at least one weighted training example for training a behavior planner for an at least partially automatically driving vehicle or a robot, wherein each training example is a tuple of a state and a corresponding specified target behavior, the method comprising the following steps:
a) extracting a state from a pre-provided initial training example as an initial state;
b) rolling out a planning strategy of the behavior planner starting from the initial state within a simulation for generating a simulated behavior;
c) terminating the simulation when a termination condition is reached;
d) evaluating the initial state and/or at least one state encountered by the simulated behavior in the simulation; and
e) weighting a training example based on the evaluation of its state and/or at least one state encountered by the simulated behavior after the state, wherein the training example is the initial training example and/or a training example newly generated based on an encountered state.

2. The method according to claim 1, wherein a maximum tolerated deviation of the simulated behavior from a desired behavior and/or an occurrence of an undesirable event is selected as the termination condition in step c).

3. The method according to claim 1, wherein, in order to achieve the termination condition in step c), a maximum tolerated number of simulation steps or a maximum tolerated simulation time is defined.

4. The method according to claim 1, wherein an evaluation point score is used for carrying out the evaluation in step d).

5. The method according to claim 4, wherein evaluation points are awarded for an occurrence of undesired behavior and/or undesirable events from a previously created selection of undesired behavior and/or undesirable events.

6. The method according to claim 4, wherein evaluation points are awarded for deviations of the simulated behavior from a target behavior, wherein a larger deviation is evaluated with more evaluation points.

7. The method according to claim 1, wherein steps a) to e) are carried out until a quality criterion is reached.

8. The method according to claim 7, wherein the quality criterion is the generation of a predefined number of weighted training examples.

9. The method according to claim 1, wherein steps a) to e) are carried out during an ongoing training of the behavior planner.

10. The method according to claim 9, wherein training examples are selected and/or sorted for at least one training epoch based on their weighting and this selection and/or sorting is used as a basis for at least one training epoch.

11. The method according to claim 9, wherein the training of the behavior planner is carried out based on a differentiable simulation.

12. The method according to claim 1, wherein a loss function value is multiplied by a weighting factor prior to carrying out backpropagation, the weighting factor depending on a weighting of a training example causal for the loss function value.

13. The method according to claim 1, wherein at least one weighted training example generated in accordance with the method is used for training the behavior planner.

14. A behavior planner for an at least partially automatically driving vehicle and/or a robot, the behavior planner being trained using a method for generating at least one weighted training example for training the behavior planner, wherein each training example is a tuple of a state and a corresponding specified target behavior, the method comprising the following steps:
a) extracting a state from a pre-provided initial training example as an initial state;
b) rolling out a planning strategy of the behavior planner starting from the initial state within a simulation for generating a simulated behavior;
c) terminating the simulation when a termination condition is reached;
d) evaluating the initial state and/or at least one state encountered by the simulated behavior in the simulation; and
e) weighting a training example based on the evaluation of its state and/or at least one state encountered by the simulated behavior after the state, wherein the training example is the initial training example and/or a training example newly generated based on an encountered state.

15. The behavior planner according to claim 14, wherein the behavior planner is a trajectory planner.

16. An automatically driving vehicle, comprising:
a behavior planner trained using a method for generating at least one weighted training example for training the behavior planner, wherein each training example is a tuple of a state and a corresponding specified target behavior, the method including the following steps:
a) extracting a state from a pre-provided initial training example as an initial state;
b) rolling out a planning strategy of the behavior planner starting from the initial state within a simulation for generating a simulated behavior;
c) terminating the simulation when a termination condition is reached;
d) evaluating the initial state and/or at least one state encountered by the simulated behavior in the simulation; and
e) weighting a training example based on the evaluation of its state and/or at least one state encountered by the simulated behavior after the state, wherein the training example is the initial training example and/or a training example newly generated based on an encountered state.

17. A robot, comprising:
a behavior planner comprising:
a behavior planner trained using a method for generating at least one weighted training example for training the behavior planner, wherein each training example is a tuple of a state and a corresponding specified target behavior, the method including the following steps:
a) extracting a state from a pre-provided initial training example as an initial state;
b) rolling out a planning strategy of the behavior planner starting from the initial state within a simulation for generating a simulated behavior;
c) terminating the simulation when a termination condition is reached;
d) evaluating the initial state and/or at least one state encountered by the simulated behavior in the simulation; and
e) weighting a training example based on the evaluation of its state and/or at least one state encountered by the simulated behavior after the state, wherein the training example is the initial training example and/or a training example newly generated based on an encountered state.
